(19) United States
(12) Patent Application Publication
(10) Pub. No.: US 2012/0062049 A1
(43) Pub. Date: Mar. 15, 2012

(54) ELECTROMECHANICAL ENERGY CONVERTER

(75) Inventors: Daniel Baur, Obereschach (DE); Bernhard Blocher, VS-Schwenningen (DE); Werner Karpen, Villingen-Schwenningen (DE); Vladimir V. Popov, Villingen-Schwenningen (DE); Guido Schmid, Triberg (DE); Stefan Schwamberger, Lohsa Ot. Hermsdorf (DE); Thomas Trietz, Villingen-Schwenningen (DE)

(73) Assignee: MINEBEA CO., LTD., Nagano-ken (JP)

(21) Appl. No.: 13/227,958

(22) Filed: Sep. 8, 2011

(30) Foreign Application Priority Data
Sep. 10, 2010 (DE) 10 2010 045 063.4
Aug. 17, 2011 (DE) 10 2011 110870.3

(51) Int. Cl. H02K 35/00

(52) U.S. Cl. 310/28

(57) ABSTRACT

An electromechanical energy converter (1) is provided that can convert mechanical vibration energy into electrical energy. For this purpose, the energy converter (1) has a housing (2) in which a coil (12) and a permanent magnet (15) are disposed moveable with respect to each other, the coil (12) lying within the magnetic field of the magnet (15). To fully utilize the entire field intensity of the magnet (15), flux guides (18) are disposed at the poles of the magnet (15) that divert the magnetic flux lines (17) substantially in the direction of the coil (12).

### CROSS-SECTION TO RELATED APPLICATIONS

This application claims the benefit of German Patent Application No. DE 2010 045 063.4, filed Sep. 10, 2010, and a second German Patent Application having the same title and the same inventors as the first German Patent Application noted above which has not been assigned an application number as of the time for filing this application, both of which are incorporated herein by reference as if fully set forth.

### BACKGROUND

The invention is directed to an electromechanical energy converter for converting mechanical vibration energy into electrical energy having a housing with at least one coil and at least one permanent magnet, the coil and the magnet being so disposed in the housing that on movement of the housing a relative movement between the magnet and coil takes place, thus causing a current to be induced in the coil.

These kinds of energy converters are also called energy harvesters because they can absorb energy from their surroundings, “harvest” it, and convert it into electrical energy. In the described energy converter, mechanical kinetic energy as created, for example, during the operation of a motor or a machine or by people using mobile devices such as watches, mobile telephones, MP3 players, and various remote controls etc., is converted into electrical energy. Aside from this, there are also energy converters that are able to convert such variables as heat, differences in temperature or light into electrical energy.

The energy converter is thus suitable for a decentralized and autarkic supply of energy, for example, for sensors, handheld devices or other energy consumers. These kinds of energy converters are gaining in importance because they allow such applications as monitoring systems, sensors or remote controls to be independently supplied with electrical energy. Complex and expensive wiring of individual systems is thus no longer necessary.

Alongside the price, the crucial factors for any application are, in particular, the dimensions and the efficiency of such energy converters.

### SUMMARY

The object of the invention is thus to provide an energy converter of the type described above that has compact dimensions and an improved energy yield compared to known systems.

This object has been achieved according to the invention in that a flux guide is disposed on each of the magnetic poles of the permanent magnet, the flux guide concentrates the magnetic flux substantially in the direction of the coil.

To enable an energy converter as described above to serve a wide range of applications, it should be made as compact as possible. As a rule, the dimensions of the coil are made to conform to the dimensions of the magnet. The magnetic flux lines enclose the entire magnet and reach far into the surrounding area. Consequently, many flux lines pass by the coil and are thus not available for inducing a current in the coil and, moreover, cause undesirable magnetic leakage flux.

The flux guides according to the invention now collect the flux lines at the magnetic poles and focus them in the direction of the coil. This means that the natural flux paths are diverted by the plates and they now run mainly in the plate rather than in the surrounding area. The concentrated flux lines then emerge from the short sides of the plates that are preferably located directly opposite the coil. This goes to minimize the magnetic leakage field, resulting in an increase in the field intensity in the coil. For the same movement of the magnet, a greater electromagnetic force (EMF) is thereby induced and consequently a larger current in the coil. Using this simple measure, it is possible to approximately triple the current yield.

In a preferred embodiment of the invention, the at least one coil is fixedly disposed on the housing and the at least one permanent magnet is disposed on a vibrating arm. The vibrating arm ensures that a movement of the housing is transformed into a one-dimensional vibrational movement of the magnet, provided that a component of the housing movement is in the direction of the vibration direction of the vibrating arm.

The coil is preferably designed as a flat coil being substantially oblong or cylindrical in shape. It is advantageous if the magnet is also made substantially oblong in shape.

It is clear that the flat coil could also be given a different form, such as a circular or oval shape, the shape of the magnet being made to conform accordingly.

The vibrating arm preferably has at least two fingers, a magnet being disposed on each finger and a coil being disposed between the fingers. Each coil is thus enclosed by two magnets whose magnetic field passes through the coils.

The flux guides are preferably disposed at the end faces of the magnets. The magnets may also be made up of a plurality of part magnets, flux guides being disposed only on the outer poles.

It is advantageous if the flux guides are aligned such that when the vibrating arm is at a standstill, the magnetic flux is substantially concentrated at the centre of the coils.

A further advantageous embodiment of the invention provides for the vibrating arm to have more than two fingers, a magnet being disposed on each finger and a coil being disposed on the housing between all fingers. By connecting the coils, the current yield can be easily multiplied.

To make the vibrating arm readily responsive to a vibration, it is advantageous if it is given a substantially tongue-like shape and one end is firmly fixed to the housing. The thickness of the vibrating arm is thereby substantially smaller than its width and its length.

It is advantageous if the vibrating arm is made at least partially of spring steel that preferably has low mechanical damping.

Another embodiment of the invention provides for a magnet to be moved between two coils. So as to additionally concentrate the magnetic flux on the coil, a magnetic back yoke can be disposed on the side of the coil facing away from the magnet, the magnetic back yoke closing the flux lines behind the coil. This has the added advantage that the magnetic field does not escape as an interference field out of the housing towards the outside.

### BRIEF DESCRIPTION OF THE DRAWINGS

The invention is described in more detail below on the basis of several embodiments with reference to the enclosed drawings.

In the drawings:

FIG. 1 is an oblique view of a first embodiment of the invention having a coil and two or four magnets,

FIG. 2 is a sectional view of FIG. 1,

FIG. 3 is a view of a second embodiment of the invention having three coils and four or eight magnets,

FIG. 4 is a detailed view of the vibrating arm of FIG. 3,

FIG. 5 is a view of a preferred embodiment of the invention having a magnet and two coils each having a magnetic back yoke,

FIG. 6 is a view of a further embodiment of the invention having two coils that are disposed on a common coil core which also acts as a magnetic back yoke for the magnet,

FIG. 7 is a view of a further embodiment of the invention having one coil that is disposed on a coil core which also acts as a magnetic back yoke for the magnet,

FIG. 8 is an oblique view of a preferred embodiment of the invention according to FIG. 5,

FIG. 9 is a cross-sectional view of the embodiment of FIG. 8 through the vibrating arm,

FIG. 10 is an exploded view of the embodiment of FIG. 8,

FIG. 11 is a block diagram of a voltage supply having an energy converter according to the invention,

FIG. 12 is a block diagram of an electric device having an energy converter according to the invention,

FIG. 13 is a block diagram of a further electric device having an energy converter according to the invention, and

FIG. 14 is a block diagram of a further electric device having an energy converter according to the invention.

### DETAILED DESCRIPTION OF THE PREFERRED EMBODIMENTS

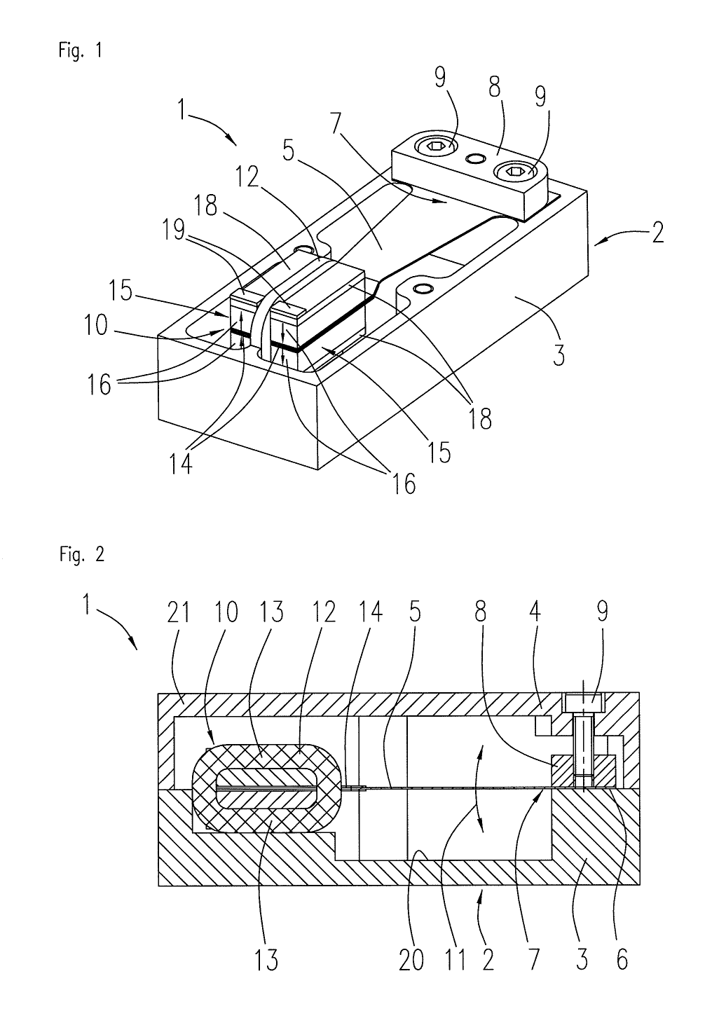

FIG. 1 shows an electromechanical energy converter according to the invention which, in its entirety, is designated by 1. The energy converter 1 is disposed in a two-piece, cuboid-shaped housing 2 that is made up of a lower housing half 3 and a removable, upper (FIG. 2) housing half 4.

A tongue-shaped vibrating arm 5 is fixed to the housing 2. For this purpose, the lower housing half 3 has a flat supporting surface 6 on which one end 7 of the vibrating arm 5 rests. The vibrating arm end 7 is fixed from above using a mounting block 8 that is fastened to the supporting surface 6 by two screws 9.

The other end 10 of the vibrating arm 5 is free. The vibrating arm 5 is made from flat sheet metal of spring steel, such that it can vibrate within the housing 2 in a vibration direction 11.

Moreover, a coil 12 is fixed to the lower housing half 3. The coil 12 is formed as a flat coil that is aligned parallel to the vibration direction 11 (FIG. 2). In the example, the coil 12 is substantially oblong in shape, the two long coil sides 13 lying parallel to the vibrating arm 5 in its non-deflected position.

At its free end 10, the vibrating arm 5 has two fingers 14 on each of which at least one permanent magnet 15 is disposed. In the example, the magnets 15 are cuboid in shape and magnetized in the vibration direction 11. This means that in the illustration, the top is, for example, the north pole and the bottom is the south pole. In the illustrated embodiment, the magnets 15 are formed from two part magnets 16 that are fixed on the fingers 14, above and below the sheet metal respectively. The magnets 15 may, however, also be integrally formed as one piece and fixed elsewhere on the fingers 14 or on the vibrating arm 5.

The fingers 14 are spaced only so far apart from each other that the coil 12 is disposed with the smallest possible air gap between the fingers 14, and thus between the magnets 15.

The magnets 15 simultaneously form the vibratory mass for the vibrating arm 5. When there is a movement of the housing 2, the vibrating arm 5 is incited to vibrate due to the inertia of the vibratory mass. The magnets 15 thereby move parallel to the coil 12 causing the magnetic field within the coil 12 to change. According to the law of induction, a current is thereby induced in the coil 12.

The coil 12 and/or the magnet 15 may have other shapes differing from the illustrated example, such as a cylindrical shape.

On a permanent magnet 15, the flux lines flow between the two magnetic poles N and S generally on closed paths that reach far into the surrounding area. This means that in the energy converter 1, a significant portion of the flux lines pass by the coil 12. These flux lines are thus not available for inducing a current.

To increase the current yield compared to the prior art, according to the invention flux guides 18 are disposed at the magnetic poles 15, the flux guides 18 concentrating the flux lines substantially in the direction of the coil 12. The flux guides 18 are preferably made of a ferromagnetic material so that the magnetic flux can be guided unhindered as far as possible. The flux guides 18 are made, for example, from soft magnetic iron.

The flux guides 18 now ensure that as many flux lines as possible are collected and diverted in the direction of the coil 12. This makes the magnetic field within the coil 12 significantly stronger, which in turn allows a larger current to be induced in the coil 12.

The flux guides 18 are preferably disposed on the outer magnetic poles of the part magnets 16.

Stop buffers 19 are additionally fixed to the flux guides 18, which, on strong vibrations of the vibrating arm 5, hit against the housing base 20 or cover 21 and prevent any damage to the magnets 15 and the housing 2. These buffers 19 are made, for example, of plastics or rubber or any other damping material.

The flux guides 18 are aligned on the magnet 15 such that when the vibrating arm 5 is at a standstill, the flux lines are substantially guided to the long sides of the coil 13. For this purpose, the magnets 15 are dimensioned such that the flux guides 18 are disposed substantially opposite the coil sides 13.

Thanks to the flux guides 18 according to the invention, the current yield of the energy converter 1 according to the invention is up to three times higher than for the prior art.

As an alternative to the embodiment illustrated here, the coil 12 could also be disposed on the vibrating arm 5 and the magnets 15 fixedly disposed on the housing 2.

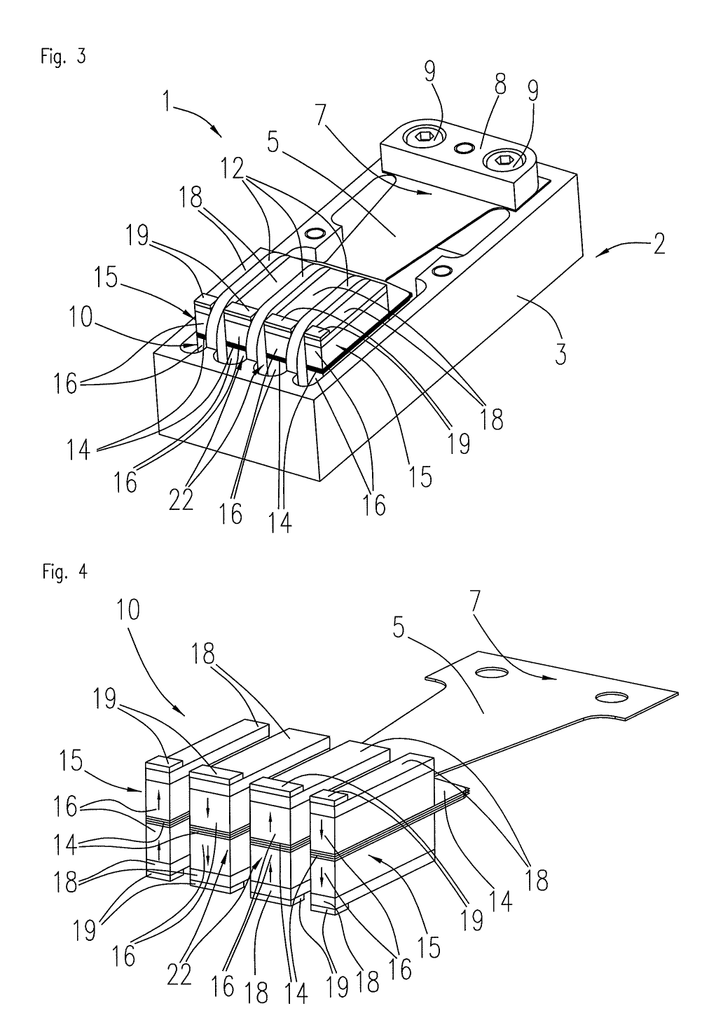

To achieve an even greater current yield, a plurality of coils 12 could also be connected in the energy converter 1 in series or in parallel. In FIG. 3, such an alternative energy converter 1 having three coils 12 is shown. The construction corresponds substantially to the energy converter of FIG. 1. The vibrating arm 5, however, has four fingers 14, where between every two adjacent fingers 14, a coil 12 fixedly attached to the housing 2 is disposed. Compared to the outer magnets 15, the two middle magnets 22 are made almost double as wide since they are dimensioned for two coils 12.

FIG. 4 once again shows the construction of the vibrating arm 5 having four fingers 14. Here, the construction of the magnets 15 made up of two part magnets 16 can be seen more clearly. Except for the number of fingers, the vibrating arm of FIG. 1 is identical. It is clear that the vibrating arm may, for example, have three fingers or any arbitrary number of fingers.

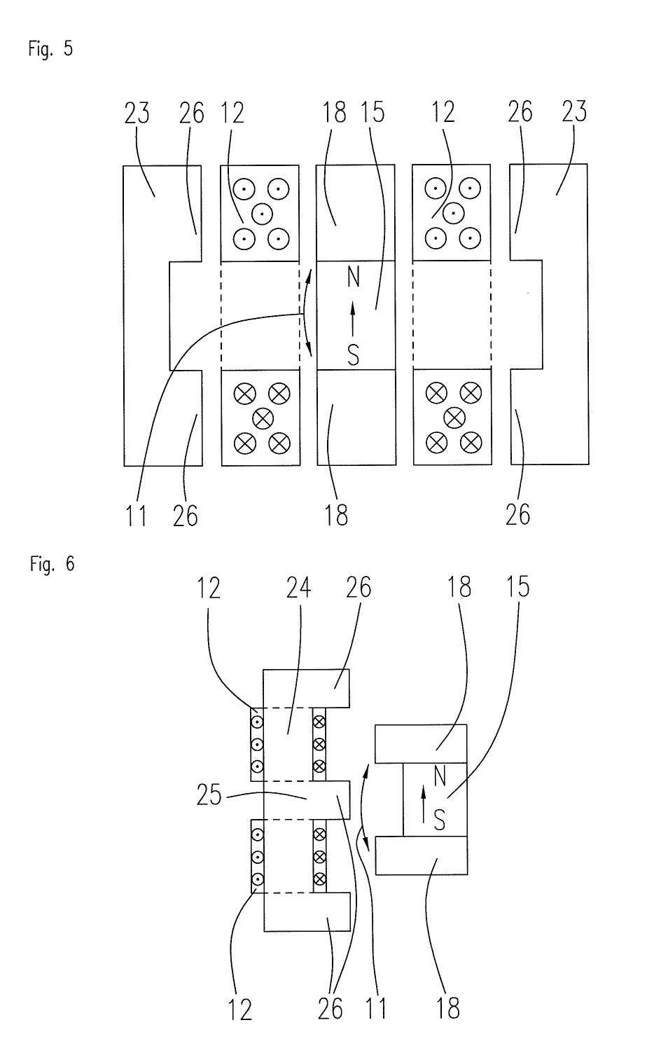

A further, preferred embodiment of the invention is schematically shown in FIG. 5. Only one single magnet 15 having flux guides 18 is disposed here on the vibrating arm 5. In the drawing, a coil 12 fixedly attached to the housing 2 is disposed respectively to the right and left of the magnet 15, the flux guides 18 of the magnet 15 here again being disposed opposite the long sides of the coils 13. On each side of the coils 12 facing away from the magnet 15, a magnetic back yoke 23 is disposed, which is made of a ferromagnetic material and by which the flux lines of the magnet 15 are largely closed and do not stray into the surrounding area. In the example, the back yoke takes the form of a U-core 23 and is made of a soft magnetic material. This goes to improve the yield since additional flux lines can be used to generate a current in the coils. In addition, the magnetic interference field of the generator towards the outside is reduced.

The back yoke 23 may thereby be fixedly attached to the housing or moveably attached to the magnet 15. Moreover, it is also possible, alongside the single magnet 15, to provide only a single coil 12.

A further embodiment of the invention according to FIG. 6 provides that the magnetic back yoke simultaneously acts as a coil core for the coil 12. In the illustrated example, the magnetic back yoke takes the form of an E-core 24 that can be stacked, for example, from individual iron laminations. Two coils 12 are disposed on the core 24, each coil 12 being wound around the back 25 of the core 24. The effective magnetic field in this embodiment is conducted solely in the core 24.

On vibration of the magnet 15 with respect to the core 24, the flux guides 18, which in this embodiment project laterally from the magnet 15, sweep by the limbs 26 of the E-core 25. Depending on the position of the magnet 15, a flux reversal is thereby produced in the core 24, thus inducing a particularly large current. This embodiment consequently goes to produce an even greater yield which is why even extremely small-scale constructions have a large energy yield.

For the sake of symmetry, it is advantageous in this embodiment if another core having coils is disposed on the other side of the magnet 15 (not illustrated).

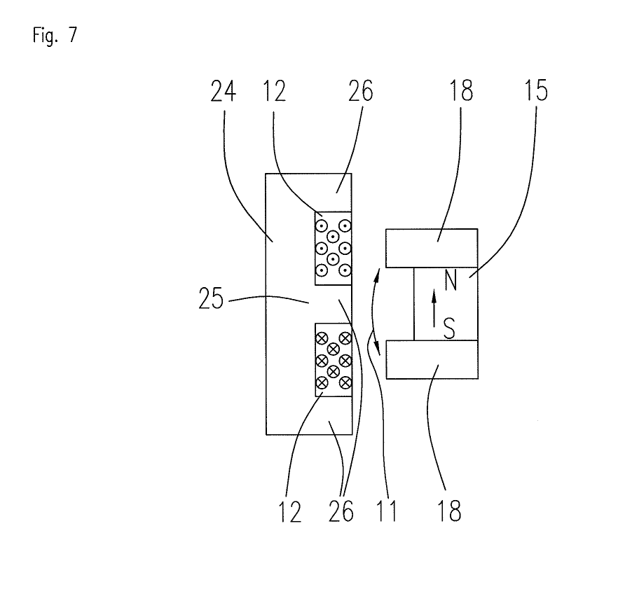

A further variant of the embodiment, illustrated in FIG. 7, provides a permanent magnet 15, unchanged with respect to FIG. 6 and likewise having flux guides 18 disposed at the end faces, that is located opposite an E-core 24. In this arrangement only one single coil 12 is provided that is wound around the middle core limb 26 of the E-core 24. An important advantage of the embodiments according to FIGS. 6 and 7 is that the air gap between the permanent magnet 15 and the coil core 24 can be kept comparatively small.

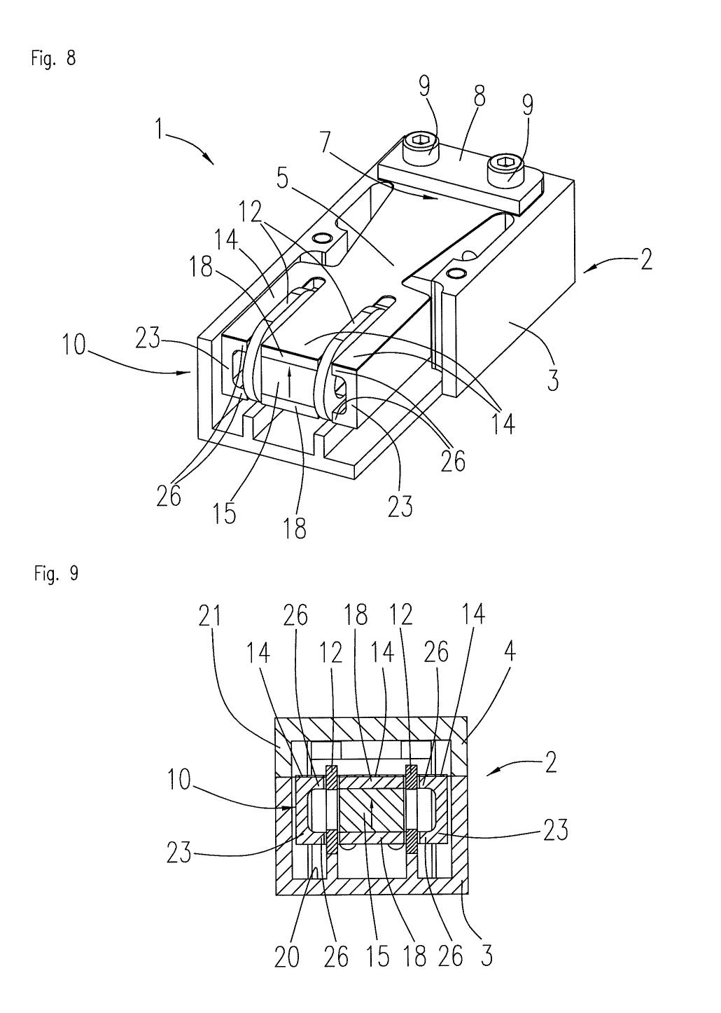

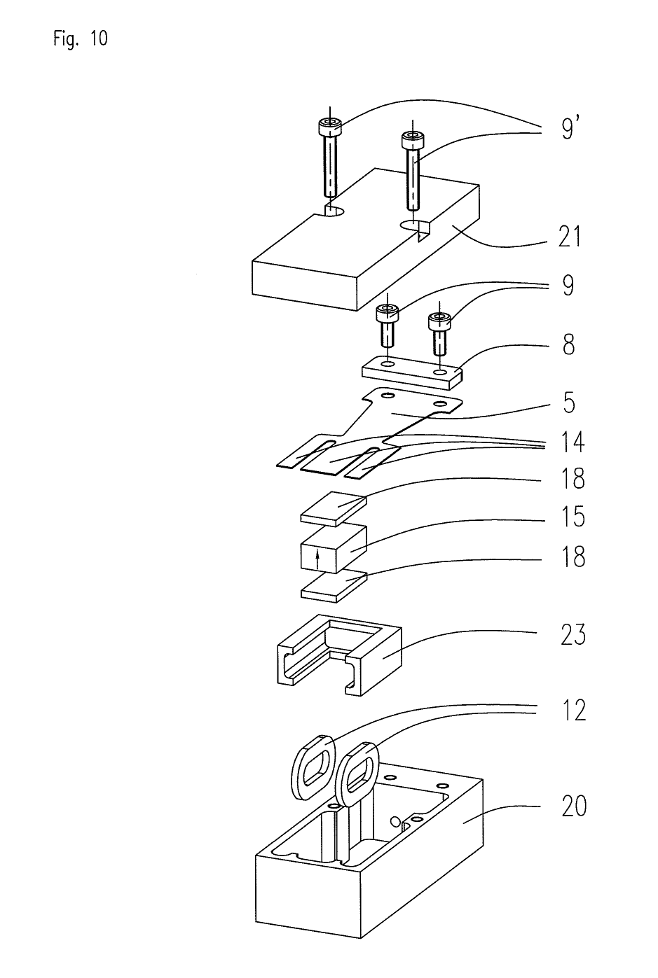

FIGS. 8 to 10 show a preferred realization of the embodiment according to FIG. 5. The energy converter is constructed in substantially the same way as the energy converter of FIG. 1.

Here, however, the vibrating arm 5 has three fingers 14, the middle finger being wider than the two outer fingers. A permanent magnet 15 is disposed on the middle finger that is magnetized in the vibration direction and that has a flux guide plate 18 at each of the upper and lower end faces. A U-shaped back yoke 23 (FIG. 10) is further disposed on the vibrating arm 5, the limbs of the back yoke 23 being disposed on the outer fingers. The limbs of the back yoke 23 themselves are U-shaped, these limbs 26 being aligned opposite the flux guides 18 when the vibrating arm 5 is in a non-deflected state. Two ring coils 12 fixedly attached to the housing are disposed between the fingers 14.

In the illustrated embodiment, the magnet 15 and the back yoke 23 are disposed on the underside of the vibrating arm 5.

The housing cover 21 in this embodiment is screwed onto the housing base 20 using two separate screws 9′ (FIG. 10).

It is clear that the invention is in no way limited to the illustrated embodiments. Wherever a stationary coil and a moving magnet are described, it is also basically possible to have the magnet stationary and the coil moving. Likewise, almost any desired number of coils and magnets can be chosen. Thus, for example, a plurality of magnets can be stacked with a flux guide being disposed between each magnet.

In particular, the magnetic back yoke according to FIG. 5 or according to FIG. 7 may form a part of the housing or the housing may act as a magnetic back yoke. Moreover, the arrangement of the magnet 15 and the back yokes 18 may be interchanged in that in the position of the permanent magnet 15, a ferromagnetic back yoke is disposed, and in that instead of the back yokes 18, magnetized permanent magnets are disposed at the end faces of the back yoke perpendicular to the vibration plane 11.

An energy converter 1 according to the invention may, for example, be installed in a voltage supply 27 for supplying an electric device. The advantage here is that, due to the energy converter 1, the voltage supply 27 is autarkic and there is no need for connection to a mains power supply.

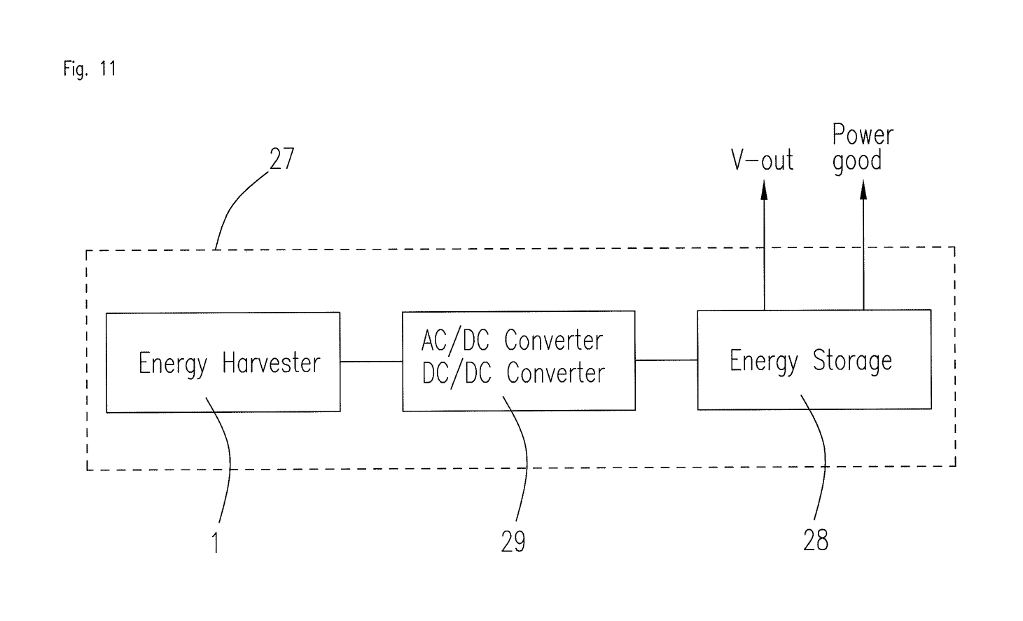

FIG. 11 shows a block diagram of this kind of voltage supply 27 having an energy converter 1 and an energy storage unit 28 for the intermediate storage of the converted energy.

Depending on the conversion principle, the energy converter 1 delivers either an AC voltage or a DC voltage. In order to adjust this conversion voltage to the operating or charging voltage of the energy storage unit 28, a voltage converter 29 is provided. In accordance with the conversion voltage of the energy converter, this converter takes the form of an AC/DC inverter or a DC/DC converter. The conversion voltage of the energy converter 1 may thereby be higher or lower than the charging voltage of the energy storage unit 28. The voltage converter 29 is accordingly designed as an up and/or down converter.

The voltage supply 27 has an output for a supply voltage V_out, at which a regulated DC voltage is available to supply any desired electric device. In addition, the voltage supply provides a control signal that shows the availability of the supply voltage.

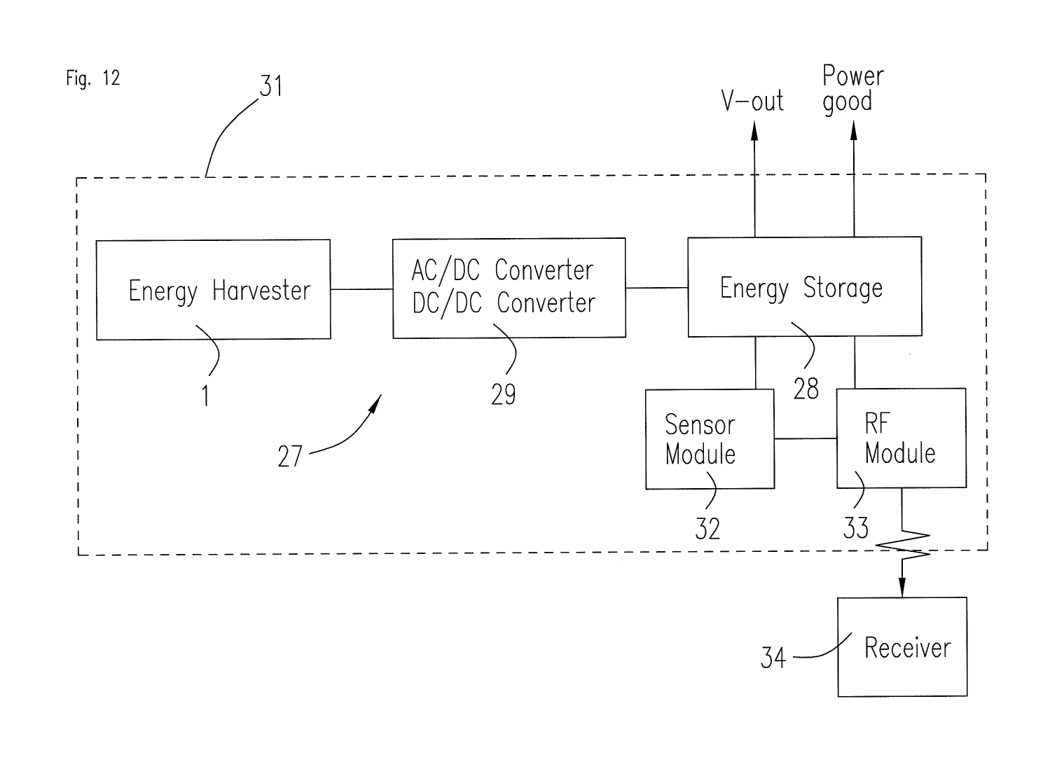

In FIG. 12 an electric device 31 is schematically shown that has an energy converter 1 according to the invention having a voltage supply 27 according to FIG. 11. The electric device 31 has optionally a supply voltage output V_out and a control signal that can be used for the voltage supply of any other electric devices with or without their own energy converter.

In the example, the electric device 31 additionally has a sensor module 32 and a transmitter module 33.

The sensor module 32 comprises at least one sensor and an evaluation circuit for the sensor values that may, for example, be realized by a microcontroller. The sensor may, for example, be a temperature, pressure and/or humidity sensor.

The sensor values can be transmitted via the transmitter module 33 to a remote receiver 34 where they can be further processed and analyzed.

Such an electric device 31 can, for example, be used in a production plant for monitoring critical process variables. Here, the advantage is that the electric device 31 according to the invention can function without any wiring whatsoever and can thus be easily mounted and used everywhere.

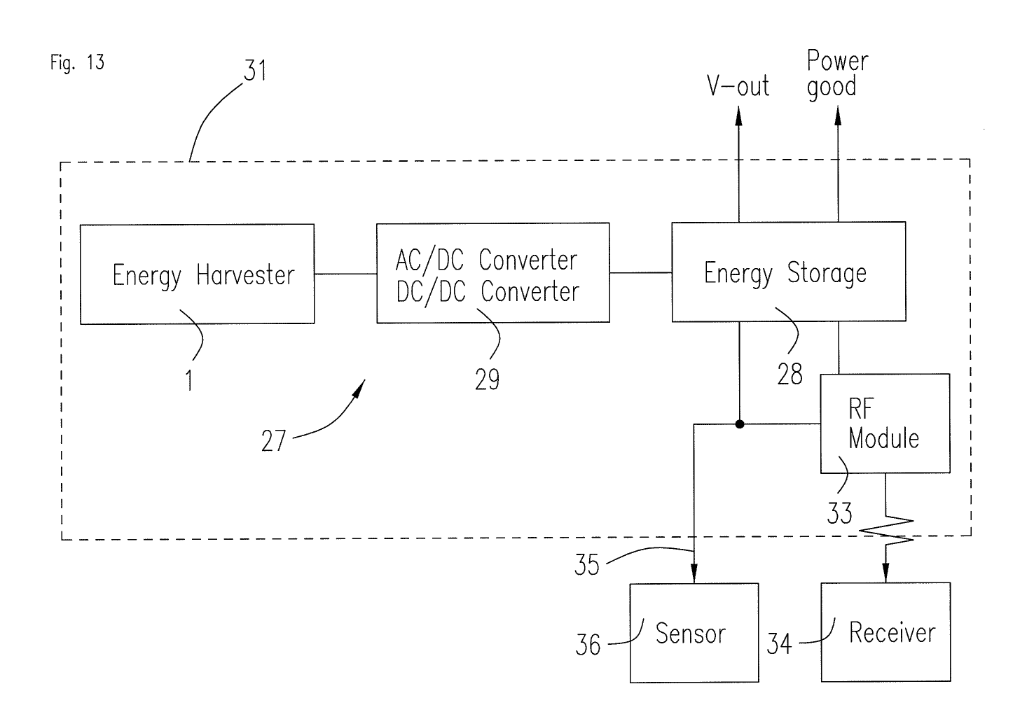

The variant of the electric device of FIG. 12 shown in FIG. 13 does not have a sensor of its own. Here instead, there is only an interface 35 for connecting one or more external sensors 36.

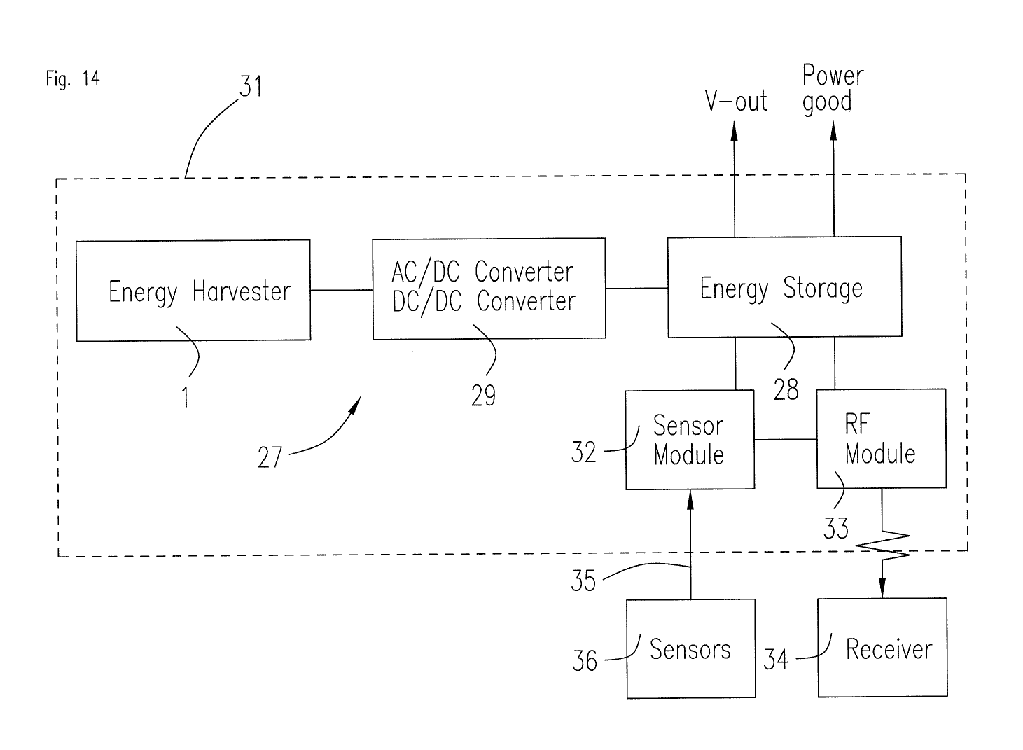

It is clear that the device of FIG. 12 may also have in addition to its own built-in sensor module 32, an interface 35 for connecting external sensors 36 as is shown in FIG. 14.

Alongside its transmitting capacity, the transmitter module 33 may be additionally or alternatively designed to also receive sensor values from adjacent equivalent devices, control signals or other signals.

The illustrated electric devices 31 are not restricted to the use of a mechanical energy converter 1. Alternatively or additionally, other kinds of energy can be used to produce the supply voltage.

### REFERENCE NUMBERS

1 Electromechanical energy converter

2 Housing

3 Lower housing half

4 Upper housing half

5 Vibrating arm

6 Supporting surface

7 Fixed end (vibrating arm)

8 Mounting block

9,9′ Screws

10 Free end (vibrating arm)

11 Plane of vibration

12 Coil

13 Long coil side

14 Fingers

15 Magnet

16 Part magnets

18 Flux guide

19 Stop buffer

20 Housing base

21 Housing cover

22 Middle magnets

23 U-core

24 E-core

25 Core back

26 Core limb

27 Voltage supply

28 Energy storage unit

29 Voltage converter

31 Electric device

32 Sensor module

33 Transmitter module

34 Receiver

35 Sensor interface

36 Sensor

V_out Supply voltage output

1. An electromechanical energy converter for converting mechanical vibration energy into electrical energy, comprising at least one coil (12) and at least one permanent magnet (15) having magnetic poles, the coil (12) and the magnet (15) being disposed such that on movement of the energy converter, a relative movement between the magnet (15) and the coil (12) is adapted to take place, thus causing a current to be induced in the coil (12), a flux guide (18) is disposed on each of the magnetic poles of the permanent magnet (15), the flux guides (18) are adapted to concentrate the magnetic flux lines (17) substantially in a direction of the coil (12).

2. The electromechanical energy converter according to claim 1, wherein the at least one coil (12) is fixedly attached to a housing (2) and the at least one permanent magnet (15) is disposed on a vibrating arm (5) connected to the housing (2).

3. The electromechanical energy converter according to claim 1, wherein the coil (12) is a flat coil that is substantially oblong in shape.

4. The electromechanical energy converter according to claim 2, wherein the vibrating arm (5) has at least two fingers (14), and one of the magnets (15) is disposed on each of the fingers (14) and the coil (12) is disposed between the fingers (14).

5. The electromechanical energy converter according to claim 4, wherein the flux guides (18) are disposed at end faces of the poles of the magnets (15).

6. The electromechanical energy converter according to claim 2, wherein the flux guides (18) are aligned such that when the vibrating arm (5) is at a standstill, the flux lines (17) are concentrated substantially at a middle of long sides (13) of the coil.

7. The electromechanical energy converter according to claim 2, wherein the vibrating arm (5) has more than two fingers (14), one of the magnets (15) being disposed on each of the fingers (14) and the coils (12) are disposed on the housing (2) between all of the fingers (14).

8. The electromechanical energy converter according to claim 1, wherein a magnetic back yoke (23; 24) is disposed on a side of the coil (12) facing away from the magnet (15).

9. The electromechanical energy converter according to claim 8, wherein the energy converter (1) provides that the magnet (15) is moveably disposed between two stationary ones of the coils (12) and the magnetic back yoke (23; 24) is disposed on a side of the coil (12) facing away from the magnet.

10. The electromechanical energy converter according to claim 2, wherein the vibrating arm (5) is has a tongue-like shape and is firmly fixed at one end to the housing (2).

11. The electromechanical energy converter according to claim 2, wherein the vibrating arm (5) is at least partially made of spring steel.

12. The electromechanical energy converter according to claim 8, wherein the magnetic back yoke is made up of an E-core (24), at least one of the coils (12) is wound on a back (25) or around a limb (26) of the E-core (24).

13. The electromechanical energy converter according to claim 4, wherein the magnets (15) and the flux guides (18) are disposed on the fingers (14) of the vibrating arm (5) and that the coils (12) are stationary.

14. The electromechanical energy converter according to claim 1, wherein the coils (12) are fixed to a vibrating arm (5) and the magnets (15) as well as the flux guides (18) are stationary.

15. A voltage supply (27) having an energy converter (1), a voltage converter (29) and an energy storage unit (28) and having an electromechanical energy converter (1) according to claim 1.

16. An electric device having a voltage supply according to claim 15.
